(19) United States
(12) Patent Application Publication
(10) Pub. No.: US 2010/0041554 A1
(43) Pub. Date: Feb. 18, 2010

(54) CONTROL OF PATHOGENS IN PLANTS, AND AN EFFICIENT MEANS TO ADD NUTRIENTS AND MICRONUTRIENTS TO PLANTS

(76) Inventor: Michael Richard Musumeci, San Jose, CA (US)

Correspondence Address: Michael R. Musumeci, 949 Yarmouth Way, San Jose, CA, 95120, US

(21) Appl. No.: 12/193,123

(22) Filed: Aug. 18, 2008

(51) Int. Cl. A01N 59/20; A01P 3/00; A01P 21/00

(52) U.S. Cl. 504/121; 424/637

(57) ABSTRACT

This invention consists of a new and novel chemical composition and application method for the control of a number of different types of plant pathogens. A homogeneous aqueous solution is prepared consisting of one or more metallic compounds, a natural product adjuvant for acidifying and forming the complex ions of these metals, and a surfactant. This resulting solution is applied to all plant surfaces down to the soil line until obvious runoff. This application is repeated periodically to totally and completely halt and interrupt the plant pathogen's life cycle in 1-8 weeks during the growing season with more restricted application during the dormant period for prophylactic purposes. This new composition of matter and method of application also serves as a very efficient method to add nutrients and micronutrients to the plant, and to control animal and plant pathogens that reside on a plant host.

### CROSS-REFERENCED TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This patent specification refers to Disclosure Document #604226 filed on Aug. 1, 2006 by the above inventor, Michael R. Musumeci. A properly certified copy of this Disclosure Document is retained by the inventor in support of his claim as first to invent.

Peach leaf curl is a persistent plant pathogen that affects the appearance and yield of peaches and nectarines both during tree growth and during storage following harvest. This pathogen is a fungus known as Taphrina deformans and its treatment has remained unchanged for many years relying primarily on dormant sprays containing copper (Gubler, 2006; Diver and Mumma, 2003; Toman, 2003; Longstroth, 2005; Steiner and Biggs, 1998).

The mode of action of these dormant sprays ultimately depends on an accumulation of insoluble copper hydroxo-carbonate on the surface of the plant. Copper ion is slowly released by contact with any one of a number of weak acids which are always present in the environment. Copper ion is the active agent that is responsible for the fungicidal action of these treatments (Equation #1).

[Cu(OH)]₂CO₃+3HA_{(aq)}→2Cu²⁺_{(aq)}+3A⁻_{(aq)}+1HCO₃¹⁻_{(aq)}(slow) Equation #1

A particularly severe outbreak of peach leaf curl occurred in the Santa Clara County of California following the heavy spring rains in April of 2006. This particular outbreak did not respond to any of the commercially available pesticides for peach leaf curl control due in substantial part to the heavy rains which washed away all residues corresponding to copper (II) hydroxocarbonate and similarly composed residues and all organic pesticides and their residues. An alternate method consisting of a new chemical composition and a new method of application was developed and found great success right away in controlling peach leaf curl. Subsequent testing indicated that this same chemical composition was effective against an array of plant pathogens in more than a dozen different plant species. The method of application is important in providing complete pathogen control.

The method of application involves periodic application during early morning hours just after sunrise during the growing season and midday application during the dormant season when temperatures are well above freezing. Since the method of application is novel and does not occur in the prior art, the review of the prior art is chiefly concerned with the uniqueness of this chemical composition.

The prior art pertaining to plant pathogens and fungicides in particular is replete with examples involving the use of transition metal salts in combination with organic heterocyclic and carbocyclic compounds containing nitrogen, oxygen, sulfur, and halogen in various combinations. Thus, Fischer (U.S. Pat. No. 6,642,180), describes an extensive array of keto-enol substituted heterocyclic and carbocyclic compounds used in conjunction with copper and zinc compounds as pesticides and herbicides. The chemical compositions described are complicated and extensive. However, the fungicidal activity is not specified and the plant toxicity seems to be a persistent problem. The extensive array of chemical compounds examined also indicates that the chemical composition and method for great success in controlling plant pathogens has not yet been discovered.

Dutzmann, U.S. Pat. No. 6,620,822, demonstrates a number of active organic compounds that consist of complex mixtures of substituted quinolines, triazoles, tolylsulfamides, dithiocarbamidates, anilines, benzimidazoles, and triazole-3-thiones. These are complicated mixtures that are going to have very complicated effects on the pathogen's biochemistry, plant's biochemistry, and eventual environmental disposition. The specific plant pathogen effectiveness is better than some previously described quinoline derivatives but is not specified. In addition, the plant toxicity of these compounds is not described in any way. Here, the copper is present in only micronutrient quantities so the main fungicidal effect appears to be due to the organic heterocyclic and carbocyclic compound mixtures which are extensive.

Doane, U.S. Pat. No. 4,911,952, describe a composition which uses amylose and amylopectin, the essential elements of starch, as a carrier for a variety of plant pesticides and medicaments. This embodiment is unique in that the carrier is completely derived from a natural source. This natural source is a macromolecule consisting of both linear and branched chain polymers of glucose. This is very useful for immobilizing the active ingredient. However, masking of the active ingredient also occurs. In addition, movement of transition metals like copper and zinc through the polymer strands is a complicated process. A variety of physical factors such as temperature, humidity, and exposure to sunlight are important in this respect and are difficult to quantify and predict. In addition, heavy rains will wash off the amylose which is water soluble and the amylopectin which is suspendable in water. Also, the presence of even a few microorganisms will metabolize both starch components directly and quickly.

Hartfeldt, U.S. Pat. No. 6,646,000, describes the use of a tannate complex of picro ammonium formate and the tannate complex of picro cupric ammonium formate in aqueous solution to treat plants for a number of pesticides including flies, mites, beetles, ants, nematodes, aphids, mealy bugs, thrips and slugs. The pesticide activity depends on two things, the increased plant tissue permeability caused by picric acid or its salts and on the injection of this tannate complex into the plant's vascular system. Picric acid has been known to increase the permeability of its solutions through plant cell walls for some time. However, its toxicity is cumulative which limits its use to one or two applications in a single growing season. In addition, any preparation that contains picric acid or its salts is necessarily a hazardous material since picric acid and its salts are oxidizers and are known to detonate without provocation. Commercial growers will most likely avoid such material especially if there is a comparable alternative without the hazardous material problem which there is in this instance. Also, injection of this tannate-picric acid-complex into the plant's vascular system is an expensive and laborious process. In addition, picro salts are expensive as well as unstable. Cupric ammonium formate is relatively expensive compared with other cupric salts. The precipitation and formation of ammonium picrate is a significant problem from this chemical composition and may also contribute to chemical instability problems.

### BRIEF SUMMARY OF THE INVENTION

This first embodiment of this invention consists of an aqueous solution of copper (II) sulfate and zinc (II) sulfate, a natural product adjuvant such as apple cider vinegar for acidifying and for forming the complex ions of these transition metal salt solutions, and a surfactant. This preparation can be applied directly to the shoot system of plants during the growing season and during the dormant season as well to totally control and halt the spread of peach leaf curl and a variety of other plant fungal pests. This response is all the more remarkable as the control over peach leaf curl was achieved during application to the plant during the growing season and not just during the dormant season like all other peach leaf curl control fungicides used before. Also, the addition of this preparation immediately produced an increase in foliage turgor and plant vitality. This effect was unexpected and synergistic because the results produce a halt in fungal diseases of plants and also serve to increase plant turgor and vitality. These results are unexpected in that the direct addition of transition metal salts to plant foliage was expected to produce the opposite effect, that is, a temporary slowdown in plant growth and vitality. The absence of any deleterious effects was also completely unexpected. The very general nature of this chemical composition suggests potential compatibility with other plant species as well.

The organic portion of this invention (apple cider vinegar and surfactant) is 100% bio-degradable so that the organic portion is completely non-toxic. In addition, copper (II) and zinc (II) ions are micronutrients for all plants. The extremely dilute nature of this invention and the manner in which it is applied allow for repeated application during the growing season with four immediate benefits, an immediate anti-microbial effect, a residual anti-microbial effect, a nutritive benefit, and an arthropod repulsive benefit. None of the constituents of this invention are harmful to plants nor is any component classified as a hazardous material. This invention does not suffer any of the shortcomings of other organic based pesticides since it does not pose an environmental hazard when properly applied nor is it toxic to plants in any way. Further, this invention demonstrates only beneficial effects which are immediately visible right after application or shortly after application to the plant.

There is absolutely no diminution in the ability of meristemic plant tissue to give rise to blossoms and fruit year over year after two years of testing on several different species of plants. The species of plants tested over a two year period include nectarine, fig, orange, coast sequoia and fuji apple. All species tested include nectarine, fuji apple, fig, cherry, seven varieties of tomatoes, five varieties of squash, four varieties of peppers, basilica, onion, gingko, coast sequoia, orange, California Poppy, and alyssum. Note that many of these plant species bloom continuously during the growing season. These plant species responded positively to treatment with this invention right away and there was no diminution in the ability of these plants to produce blossoms and fruit immediately after single or repeated application of this invention's first embodiment to these plants while blossoming continuously.

The prior art consists of scores of patents that are similar in approach to the examples cited here involving heterocyclic and carbocyclic compounds containing nitrogen, oxygen, sulfur, and halogen used in conjunction with transition metal salts, especially copper (II) and zinc (II) salts (Fischer and Dutzmann). However, typically these patents cite the limited effectiveness of these treatments and/or the accumulated plant toxicity involved. The constant search for new organic pesticides indicates that these problems are persistent and are not universally addressed by any one of these organic pesticides. The remaining relevant prior art not cited herein follows this general approach with very similar limitations as to limited or lack of effectiveness and/or accumulated plant toxicity.

The starch carrier method for delivering pesticides to plants (Doane) suffers from additional limitations as to the masking of the active ingredient by the starch, the biodegradation of starch by many different species of organisms found in agricultural fields, and by water solubility or suspend ability during rain or other high moisture events such as fog, or melting snow or ice. In addition, the method of preparation of this starch matrix is cumbersome. Commercial growers or pesticide applicators do not want to tend to a cooker in order to apply a starch matrix based pesticide to their or their clients' crops. An easier method of application would probably be preferred by most commercial applicators.

The tannate complexes of ammonium picrate with and without added copper (II) salts (Hartfeldt) represent a unique form of pesticide. However, their use is mainly concerned with the control of arthropods and only incidentally mentions these as useful against plant pathogens. The toxic nature and hazardous material status of these preparations limit their use to once or twice a growing season. In addition, application to the plant by injection is cumbersome and labor intensive. The presence of picric acid or its salts means that these are classified as hazardous materials owing to their oxidizing behavior.

My invention avoids all of these limitations. There are no toxic effects and absolutely no diminution in the ability of meristemic tissue to give rise to blossoms and fruit year over year. In addition, for those plants that bloom continuously during a single growing season such as tomatoes, peppers, egg plant, summer squash, basilica, alyssum and California Poppy, there also is not any diminution in the ability of meristemic tissue to give rise to blossoms and fruit (in the botanical sense of this word, the seed is the fruit) throughout their annual growing season. The application method for this invention is by agricultural sprayer immediately after mixing, which is very quick and convenient. This same method can be used to include other micronutrients besides copper (II) and zinc (II) ions such as boron, calcium, cobalt, iron, manganese, molybdenum, and magnesium.

### BRIEF SUMMARY OF THE SEVERAL VIEWS OF THE DRAWING

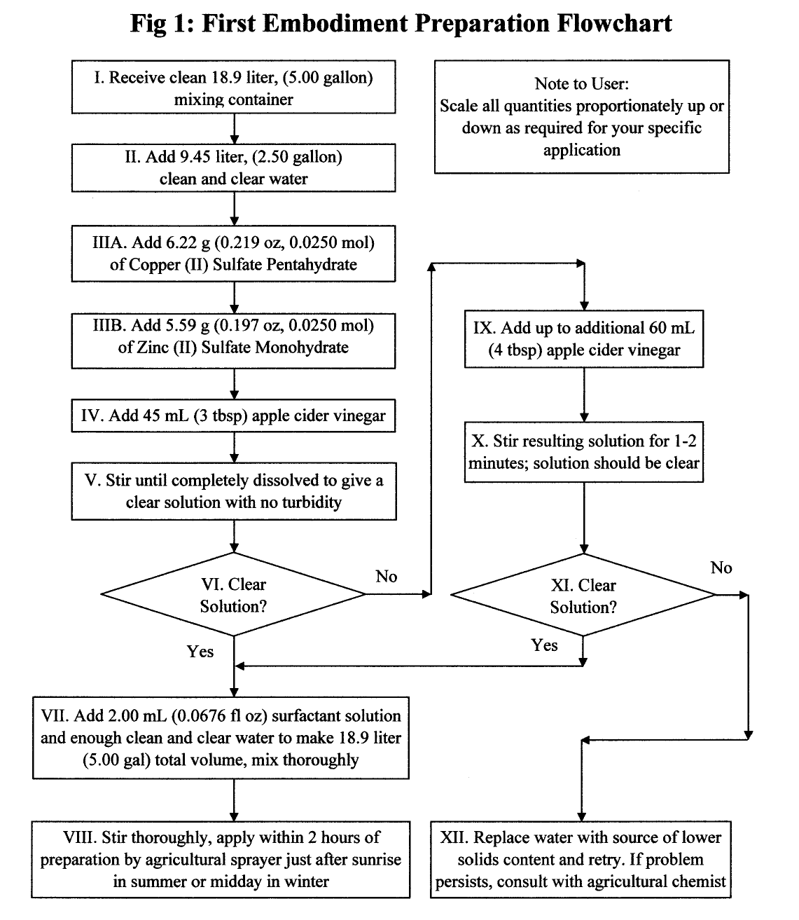

The steps required to prepare the solution that is the first embodiment of this invention are presented in FIG. 1. The required steps are presented as a flow diagram, with each step assigned a sequence number. This sequence number can be cross referenced to the corresponding discussion in the section titled “Detailed Description of the Invention—Method of Preparation” which is presented next.

### DETAILED DESCRIPTION OF THE INVENTION

### Method of Preparation

Numerical references in the following discussion refer to steps in FIG. 1 that is titled “First Embodiment Flow Chart”. The user must obtain a clean container of at least 18.9 liter (5 gal) total capacity (I). This container is half filled with 9.45 liter (2.5 gal) of clean and clear water (II). This water must be free of all dirt, sand, silt, clay, inorganic or organic particulates, and all biological organisms such as algae, protozoa, and nematodes, down to not greater than one-half micron in size. This is very important in that the presence of any protein or inorganic matrix such as clay or some similar substance must be removed or it will interfere with the pesticide action of this invention. Domestic water supply is best. If an agricultural water supply is used, it must be filtered so as to remove all particulate matter, including algae and all other biological organisms down to not greater than one-half micron in size.

Then, 6.22 g (0.219 oz, 0.0250 mol) of copper (II) sulfate (IIIA) and 5.59 g (0.197 oz, 0.0250 mol) of zinc (II) sulfate (IIIB) are added to the water and this aqueous solution is stirred for about one minute. The resulting solution will be cloudy and turbid, with only some of the metal salts dissolving into solution. Then the user will add 45 mL (3 tbsp) of apple cider vinegar to this solution (IV), followed by an additional 2-3 minutes of stirring (V). The user should make sure that this resulting solution is now completely clear without any cloudiness or turbidity whatsoever (VI). Once a completely clear solution is verified, 2 mL (0.0676 fl oz) of a surfactant solution consisting of 4.6% sodium dodecylbenzene sulfonate in 5% ethaonol in aqueous solution, is added (VII). This mixture is stirred continuously while enough additional clean and clear water is added so as to make 18.9 liter (5 gal) total volume (VIII). This solution should be stirred 1-2 more minutes to ensure that a completely homogeneous solution is obtained.

If turbidity does remain (VI) up to an additional 60 mL (4 tbsp) apple cider vinegar may be added so as to remove all turbidity (IX). The user should stir an additional 1-2 minutes (X). The user will sight down through the solution to ascertain whether the solution is clear or turbid (XI). If the solution is clear, continue with step VII. If turbidity remains, use water with a lower solids content and retry (XII). If this problem persists, consult an agricultural chemist pertaining to water quality.

Enough water is added to make the total volume up to 18.9 liter (5 gal) with additional 2-3 minutes of stirring. The resultant solution should be used within two hours of preparation and applied just after sunrise to all surfaces of the plant until completely wetted and obvious runoff down to the soil line. The user may scale all quantities up or down as required by the specific application.

The mechanism of action involves the chemical binding or coordination of copper (II) ion and zinc (II) ion to the nitrogen residues found in enzyme active sites and amino group side chains of amino acids of, for example, protein contained in the hyphae of invading fungi, the exogenous enzyme proteins secreted by pathogenic microorganisms, the protein contained in the cell walls of bacteria, the protein present in the cell wall or membrane of protozoa, or the protein envelope of viruses. Therefore, water must be absolutely free from all particulate and microbiological contamination. Domestic water supply is the best source. If an agricultural source of water is used, it must be thoroughly filtered to remove all microscopic life forms. This is very important as the presence of just a little protein or even an inorganic matrix such as clay in the water source will inactivate this invention's effectiveness. In addition, the presence of any halogen containing compounds in any equipment used to prepare or apply this invention should be completely avoided. The sources of halogen include added mineral salts and halogen containing residue from halogenated organic compounds that are used in other pesticides. Therefore, all containers, sprayers, and all associated equipment used to prepare and apply this invention must be free of all chemical and microbiological contamination and particulate matter down to not greater than one-half micron in size. In addition, under no circumstances should other pesticides be mixed together along with any embodiment of this invention described here.

### DETAILED DESCRIPTION OF THE INVENTION

### Method of Application

This solution should be applied, within two hours of preparation, to the plant or crop just after sunrise during summer, or midday during winter and much colder temperatures, by applying to all surfaces, by agricultural sprayer, of every leaf, twig, branch, and the trunk, even if apparently dead, down to the soil line until obvious runoff. Every effort should be made to remove all leaf litter from the soil line before applying this solution to the plant or crop. Dead leaf litter may and probably does harbor great numbers of pathogen spores that can defeat efforts to control such pathogens from the plant.

The object here is to interrupt the life cycle of all possible members of the pathogen population irregardless of where in the life cycle they may be found. One must also keep in mind that the pathogen spore population numbers in the tens of thousands to hundreds of thousands on just a few infected leaves. Therefore, the solution prepared according to the aforementioned procedure should be applied to all surfaces of the plant including the underside of all leaves, petioles, twigs, and branches wetting all surfaces of the plant down to the soil line. It is absolutely essential that dead plant parts including leaves, twigs, and branches, be completely wetted so as to block the spread of pathogen spores. The application of this invention can be applied twice during the dormant season for prophylactic purposes in the absence of rain or other high moisture events such as fog, snow or ice. This invention may be applied once after the last leaf falls and one more additional time just before or at the start of bud swell. Application of this invention should be avoided between two days before the appearance of blossoms and five days after the last petal fall. The plant should be carefully inspected five days to two weeks after the last petal fall so as to ascertain whether an infestation is occurring or is about to occur.

Once a determination has been made that further treatment is necessary to avoid plant pathogen infestation the following protocol may be used to control such pathogens during the growing season. The solution prepared according to the aforementioned method may be applied for the first time after the last petal fall, then reapplied two or three days later. The grower should wait a total of seven days after the first application and then reevaluate the plant or crop for effective pathogen control. If additional treatment is desired this invention's first embodiment may be applied a third time seven days after the first application, then applied for a fourth time two or three days later. At this point an additional waiting period of 7-14 days should be allowed and the plant or crop again evaluated. If desired this invention's first embodiment may again be applied a fifth time, followed by a sixth application two or three days later. An additional waiting period of seven to fourteen days should be made. After again evaluating the plant or crop for effective pathogen control, this invention's first embodiment may be applied a seventh time followed by an eight application two or three days later.

Eight applications of this invention's first embodiment are generally needed to address peach leaf curl that has infected 90-100% of the leaf area during the first one to two weeks following first leaf appearance. Only two applications of this invention's first embodiment are generally required to control peach leaf curl that has infected 10-15% or less of the total leaf area during the first one to two weeks following first leaf appearance. Also, two prophylactic treatments with this invention's first embodiment will generally limit post first leaf infestation to less than 5% of total leaf area. In such a scenario only one or two additional applications of this invention's first embodiment would be necessary to control peach leaf curl for the remainder of the growing season. However, continuous inspections should be made so as to avoid infestation from neighboring cultivars or from distant infestations carried by the wind from afar which is always possible under the right conditions. The spores of fungi are made in the range of tens to hundreds of thousands on just a few leaves during the ten to fourteen days of its life cycle during the growing season. Therefore, application to infected leaves is essential. In addition, constant vigilance is required to prevent infestation from a variety of similarly infective pathogen sources. A prophylactic protocol wherein this invention is applied once or twice during the dormant season and once or twice during the growing season is far more effective than to delay treatment of the plant or crop until after the plant pathogen's first appearance during the growing season. For those plants and crops that are annuals, a prophylactic treatment strategy wherein this invention is applied before the first pathogen appearance is far more effective in controlling these pathogens.

A further discussion is necessary regarding the best use and practice of applying this invention. The composition of matter of this invention is specific and obligatory in that it does NOT contain any plant based adjuvant, such as Aloe-Vera gel, that may hinder or completely block its effectiveness. Many of these organic based detergent substitutes contain plant extracts that have a substantial protein component. This is completely unacceptable as this would most assuredly have a negative impact on this invention's effectiveness. Therefore only surfactants of defined chemical composition may be used to formulate this invention. Such a surfactant is typically derived directly or indirectly from petroleum and a chemical synthetic pathway but not derived from a natural product based on plant or animal sources.

There are also issues with regard to soil moisture during application of the first embodiment of this invention. The “storage capacity” of soil moisture must be positive, that is, the plant must not be in a wilting state, or worse, as far as soil moisture is concerned. Otherwise, the application of this invention may do more harm than good. “Storage capacity” of soil is the amount of water in the soil that is available to the plant and can be readily absorbed through the root system. In other words, the plant must have sufficient available moisture so that water is freely transported through the plant's vascular system, and therefore, the applied metal ions and organic constituents are quickly absorbed and transported. The best time of application, then, is right after irrigation, rather than just before irrigation of the plant.

### DETAILED DESCRIPTION OF THE INVENTION

### Applicability and Scope

The mechanism of action of this invention relies on the relatively weak complex ion formed between copper (II) ion and zinc (II) ion and the acetate ion (Equation #2, Bjerrum, 1958, Pt I, p 3) compared to the much stronger complex ion formed between copper (II) ion and zinc (II) ion and

$$\begin{matrix}{Cu}_{( aq )}^{2 +} + 4 {CH}_{4} {COOH}_{( aq )} ↔ {Cu ( {CH}_{3} COO )}_{4 ( aq )}^{2 -} + 4 {H}_{( aq )}^{+} log {K}_{β4} = 2.88 & Equation \#2 \\ {Cu}_{( aq )}^{2 +} + 4 {NH}_{3 ( aq )} ↔ {Cu ( {NH}_{3} )}_{4 ( aq )}^{2 +} log {K}_{β4} = 12.67 & Equation \#3 \\ {Cu}_{( aq )}^{2 +} + 3 {NH}_{2} \text{-} {CH}_{2} \text{-} {CH}_{2} \text{-} {NH}_{2 ( aq )} ↔ {Cu ( {NH}_{2} \text{-} {CH}_{2} \text{-} {CH}_{2} \text{-} {NH}_{2} )}_{3 ( aq )}^{2 +} log {K}_{β3} = 20.03 & Equation \#4\end{matrix}$$

nitrogen containing ligands (Equation #3, Bjerrum, 1958, Pt II, P48). The nitrogen containing ligands may be as simple as ammonia or more complex as in substituted nitrogen ligands that may occur in biologically important substances. Such substances may be the amide nitrogen in polypeptides or proteins, amino side chains found in polypeptides or proteins, and the nitrogen containing side chain of histidine found in the active site of some enzymes. Biological sources of nitrogen will bind to copper (II) ion with a stability constant most like that in equation #4 (Bjerrum, 1958, Pt I, p 5). This can be seen in that these nitrogen residues are part of a protein so that the nitrogen ends of the ligands that bind to copper (II) ion are “tied together” through the polypeptide chain in much the same way that the end amino groups in ethylene diamine (NH₂—CH₂—CH₂—NH₂) are “tied together” through the carbon chain.

There is an enormous spread between the stability constant of copper (II) ion with acetate ion (Equation #2) compared to the stability constant of copper (II) ion with ethylene diamine (Equation #4). The difference amounts to 1.41×10¹⁷ which in words is nearly on the order of a billion billion. This enormous difference is exploited in the chemical composition of this invention so as to give the copper (II) ion maximum effectiveness against plant pathogens. The absence of any nitrogen or halogen containing components in this invention is the primary reason for its unexpected effectiveness against peach leaf curl and a number of other fingi and molds in several plant species tested in addition to nectarines. Furthermore, the invasive nature of plant pathogens depends on a specific chemical environment that favors invasion by the pathogen into the host organism. The application of a thin layer of copper (II) ion and zinc (II) ion that are loosely bound in an acetate ion complex derived from acetic acid changes this chemical environment to the benefit of the host and to the detriment of the pathogen. In addition, the presence of a surfactant ensures the ability of the invention to wet the surface of the pathogen to obtain maximum effectiveness in binding the nitrogen of the protein's amino and histidine side chains and amide nitrogen of peptide, polypeptide, protein, and any other biologically important molecules containing nitrogen of pathogen origin by the copper (II) and zinc (II) ions. This binding process serves to “denature” the native protein's secondary and tertiary structure so as to render such a protein “biologically inactive” and to render the associated pathogen biologically inactive and therefore “dead”. This somewhat passive and indirect mechanism is completely harmless to the plant.

A similar comparison with zinc (II) ion also indicates a similar trend to copper (II) ion. The

$$\begin{matrix}{Zn}_{( aq )}^{2 +} + 1 {CH}_{3} {COOH}_{( aq )} ↔ {Zn ( {CH}_{3} COO )}_{1 ( aq )}^{1 +} + 1 {H}_{( aq )}^{+} log {K}_{1} = 1.03 & Equation \#5 \\ {Zn}_{( aq )}^{2 +} + 4 {NH}_{3 ( aq )} ↔ {Zn ( {NH}_{3} )}_{4 ( aq )}^{2 +} log {K}_{β4} = 9.46 & Equation \#6 \\ {Zn}_{( aq )}^{2 +} + 3 {NH}_{2} \text{-} {CH}_{2} \text{-} {CH}_{2} \text{-} {NH}_{2 ( aq )} ↔ Zn {( {NH}_{2} \text{-} {CH}_{2} \text{-} {CH}_{2} \text{-} {NH}_{2} )}_{3 ( aq )}^{2 +} log {K}_{β3} = 12.93 & Equation \#7\end{matrix}$$

corresponding complex ions and formation constants are shown in Equation 5 (Bjerrum, 1958, Pt I, p 4), Equation 6 (Bjerrum, 1958, Pt II, p 50), and Equation 7 (Bjerrum, 1958, Pt I, p 6). Here we can see that there is a difference in log K of about 12, or about one thousand billion. The differences here are still extremely large again indicating that the relative stability of the ethylene diamine complex ion is far greater than that of the corresponding acetic acid complex ion derived from acetic acid. The zinc (II) ion is only very loosely bound by the acetate ion and would be bound to a much higher degree to nitrogen occurring in biologically important molecules such as peptides, polypeptides, proteins, amino and histidine side chains of amino acids, and other biologically important molecules containing nitrogen. Just as with copper (II) ion, the binding process of zinc (II) ion with nitrogen of biological origin serves to “denature” the native protein's secondary and tertiary structure so as to render such a protein “biologically inactive” and to render the associated pathogen biologically inactive and therefore “dead” by this somewhat passive and indirect mechanism that is completely harmless to the plant.

The coordination chemistry of copper (II) ion is dominated by its square planar geometry (Cotton, 1999, p 865). The coordination chemistry of zinc (II) ion is dominated by its tetrahedral geometry and, to a lesser extent, octahedral geometry (Cotton, 1999, p 611). These two metals are therefore complementary in their coordination chemistry and should have a synergistic effect in their ability to halt the growth and proliferation of plant pathogens. It should be noted that this consideration and evaluation of the coordination chemistry of copper (II) ion and zinc (II) ion forms the basis of this invention's embodiments and is not derived in any way from the prior art.

The very general nature of action of this invention makes it effective in halting the growth and proliferation of a number of different pathogens tested. This same very general nature of action of this invention would be effective against a wide array of pathogens such as fungi, mildews, molds, rusts, bacteria, and viruses. The cell membrane of bacteria and the protein coat of viruses would be just as susceptible to inactivation by denaturation and then death through binding of biologically important molecules to the copper (II) ion and the zinc (II) ion of this invention. Therefore it is asserted with a great deal of confidence that a wide array of plant pathogens can be controlled by application of this invention to plants that are cultivated for ornamental, natural product, or food source purposes.

The unexpected increase in plant turgor and vitality indicates that there is an immediate beneficial effect to the plant in the absorption of copper (II) ion and zinc (II) ion through the plant's shoot system. This same method can be used to add a number of micronutrients to the plant, for example, boron, calcium, cobalt, iron, manganese, molybdenum, and magnesium.

The embodiment described in “Method of Preparation” and schematically represented in “First Embodiment Flow Diagram” was tested over a two year period on several species of plants and pathogens and therefore represents the “First Embodiment” of this invention. However, many other embodiments of this invention very similar to this “First Embodiment” are candidates for further testing.

Apple Cider Vinegar is a natural product derived from double fermentation of apple juice. The primary carboxylic acid found in this source is acetic acid. Undoubtedly there are other carboxylic acids

$${M ( {H}_{2} O )}_{6 ( aq )}^{2 +} + {H}_{2} {O}_{( aq )} ↔ {MOH ( {H}_{2} O )}_{5 ( aq )}^{1 +} + {H}_{3} {O}_{( aq )}^{+} \\ M = {Cu}^{2 +} , {Zn}^{2 +} \qquad Equation \#8$$

found in this source as well, probably tartaric acid and citric acid. The exact identity of the complex ion formed between copper (II) ion and zinc (II) ion and the carboxylic acids in vinegar are less important than the fact that (1) such complex ions are water soluble, (2) that they suppress hydrolysis of copper (II) ion and zinc (II) ion in water (Equation #8), and (3) that they do not harm the plant in any way at the concentrations used. Furthermore, the apple cider vinegar apparently enhances the absorption of copper (II) ion and zinc (II) ion through the cuticle of the plant and into the plant's vascular system. Apple cider vinegar is a good source of carbohydrate and also contains several minerals as well which may be the reasons that apple cider vinegar does enhance absorption of copper (II) ion and zinc (II) ion by the plant. Future embodiments of this invention will rely on this view in the sense that apple cider vinegar and any subset of the constituents in apple cider vinegar or any artificially derived mixture of a subset of these constituents, whether by chemical synthesis or application of biotechnology methods, are objects for further testing of this invention and its ability to halt the growth and proliferation of plant pathogens.

This invention can also be used as an area spray to control pathogens of animals, humans, or both by treating enclosures and any other facilities or areas inhabited by animals or humans. This invention's effectiveness against such animal and human pathogens would be based on the same criteria as that for plant pathogens. Limited treatment of the bodies of animals or humans is possible in so far as application to body openings is limited and exposure of the eyes and respiratory system is completely avoided. In addition, exposure to the nose and mouth should be totally and completely avoided so as to avoid ingestion. Experience with repeated exposure to the first embodiment of this invention of less than one minute to normal and healthy skin does not produce any detectable inflammation or irritation.

Human pathogens, such as salmonella and E. coli, that dwell on the surface of food crop hosts, such as spinach and tomatoes, can also be controlled by application of an embodiment of this invention to the surface of the plant or parts thereof immediately after washing, if any, and just prior to final packaging, if any. The mechanism of action would be the same as that stated previously for plant pathogens. The relative proportions and absolute amounts of the constituents used in the embodiment of this invention for this purpose may need to be adjusted so as to comply with Food and Drug Administration (FDA) or other federal, state, and local regulations and requirements.

I claim:

1. A much improved method of chemical control of plant pathogens composed of an aqueous solution of one or more metal or non-metal salts selected from the group boron, calcium, chromium, cobalt, copper, iron, manganese, molybdenum, magnesium, nickel, zinc, nitrogen, phosphorus, potassium, and sulfur, and an natural product derived adjuvant as acidifying agent to suppress hydrolysis and to form said metal(s) complex ion(s), and a surfactant, as a method of chemical control effective against plant pathogens, said method also providing a means of adding nutrients and micronutrients to plants.

2. The first embodiment of claim 1 formulated as an aqueous solution consisting of:
6.22 g (0.219 oz, 0.0250 mol) of copper (II) sulfate pentahydrate,
5.59 g (0.197 oz, 0.0250 mol) of zinc (II) sulfate monohydrate,
45 mL (3 tbsp) of apple cider vinegar of 5% acidity,
and 2.00 mL (0.0676 fl oz) of an aqueous surfactant solution consisting of 4.6% sodium dodecylbenzene sulfonate in 5% ethanol,
said constituents dissolved in clean and clear water that is particulate free down to not greater than one-half micron in size, volume of said mixture to give 18.9 liter (5.00 gal) total volume after mixing in said order, said aqueous volume and said constituents scaled up or down according to user requirements, said aqueous solution applied to the plant or crop up to twice during the dormant period, said aqueous solution applied to the plant or crop up to eight times during the growing season, according to consideration as to moisture conditions and ambient temperature and after careful inspection of said plant or crop, said aqueous solution providing effective control against many different plant pathogens, including, but not limited to, peach leaf curl, fungi, mold, mildew, rust, white rot endemic to the Santa Clara County of California, the fungus causing “Sudden Oak Death” of oak trees in California and other locales, bacterial pathogens such as tomato bacterial wilt and blossom end rot, and viral types of plant pathogens such as tobacco mosaic virus and peach mosaic virus, and viroids.

3. The method and composition of claim 2, wherein said aqueous solution's constituents' absolute amounts and relative proportions are adjusted so as to maintain effectiveness, minimize cost, and to comply with any and all Federal, State, and Local regulations and requirements.

4. The composition of claim 2 or 3, wherein said method is modified to treat seeds of many different plants by soaking in said aqueous solution for thirty seconds or other time as determined by testing, to provide control against many different plant pathogens, including, but not limited to, peach leaf curl, fingi, mold, mildew, rust, white rot endemic to the Santa Clara County of California, the fungus causing “Sudden Oak Death” of oak trees in California and other locales, bacterial pathogens such as tomato bacterial wilt and blossom end rot, viral types of plant pathogens such as tobacco mosaic virus and peach mosaic virus, and viroids.

5. The method and composition of claim 2 or 3, wherein said apple cider vinegar is replaced by a substitute for constituents found in said apple cider vinegar, whether said constituents are presently known or yet to be discovered, or a manufactured replacement for said constituents or subset of said constituents found in said apple cider vinegar whether by chemical synthesis, biotechnology methods, or other man made means, or by some mixture of said constituents that accomplishes the same, similar, or superior result as said apple cider vinegar.

6. The method and composition of claim 2, 3, 4, or 5, wherein said surfactant solution is replaced by any one of a number of other commercially available surfactants that are 100% biodegradable and with said volume adjusted to provide the same, similar, or superior result as said surfactant solution.

7. The method and composition of claim 2, 3, 4, 5, or 6, wherein 6.22 g (0.219 oz, 0.025 mol) copper (II) sulfate pentahydrate and 5.59 g (0.197 oz, 0.0250 mol) zinc (II) sulfate monohydrate are replaced by 2.11 g (0.0744 oz, 0.0250 mol) copper (II) oxide (CuO), and 2.03 g (0.0716 oz, 0.0250 mol) zinc (II) oxide (ZnO), which are dissolved in enough said acid to completely neutralize said oxide ion and convert said oxide to the corresponding acetate or other carboxylate compound of claim 2, then followed by the addition of an equivalent amount of said acid so as to provide a 100% excess of said acid beyond that necessary to convert said oxide, so as to suppress metal hydrolysis and to provide a 100% excess of said acetate or said carboxylate anion source of claim 2, so as to form the corresponding said acetate or said carboxylate complex ion with said metal ions.

8. The method and composition of claim 7 wherein said metal oxides are either replaced by or augmented with, or proportions adjusted in relation to, other metal and non metal oxides, or other salts from the group boron, calcium, chromium, cobalt, copper, iron, manganese, molybdenum, magnesium, nickel, zinc, nitrogen, phosphorus, potassium, sulfur, and urea, which are dissolved in enough said acid to completely neutralize the oxide ions and convert said oxides to the corresponding acetate or other carboxylate compounds of claim 2, then followed by the addition of an equivalent amount of said acid so as to provide a 100% excess of said acid beyond that necessary to convert said oxides, so as to suppress metal hydrolysis and to provide a 100% excess of said acetate or said carboxylate anion source of claim 2, so as to form the corresponding said acetate or said carboxylate complex ion with said metal ions.

9. The method and composition of claim 2, 3, 4, 5, 6, 7, or 8, wherein said solution is used to control animal and human pathogens when applied as an area spray to enclosures and any other facilities or areas inhabited by said animals or humans, treatment of the bodies of which may be possible, but must be limited so as to not apply said solution to any area near body openings, especially the eyes, all parts of the respiratory system, and the nose and mouth, in order to totally and completely avoid ingestion.

10. The method and composition of claim 2, 3, 4, 5, 6, 7, 8, or 9, wherein said solution is used to control animal and human pathogens, including but not limited to Salmonella and E. coli bacteria, as a prophylactic measure, when applied to the surface of plants or parts thereof used for food just after process washing, if any, and just before final packaging, if any, including, but not limited to, spinach and tomatoes.
